(19) United States
(12) Patent Application Publication
(10) Pub. No.: US 2002/0192837 A1
(43) Pub. Date: Dec. 19, 2002

(54) Trace anion detection in liquid samples

(75) Inventors: Steven Van Tendeloo, Schoten (BE); Peter Steurs, Vosselaar (BE)

Correspondence Address: Paul D. Greeley, Esq, Ohlandt, Greeley, Ruggiero & Perle, L.L.P., One Landmark Square, 10th Floor, Stamford, CT, 06901-2682, US

(73) Assignee: Arch Specialty Chemicals, Inc., Norwalk, CT (US)

(21) Appl. No.: 09/802,186

(22) Filed: Mar. 8, 2001

(51) Int. Cl. G01N 1/18

(52) U.S. Cl. 436/177; 436/100; 436/101; 436/124; 436/125; 436/175; 436/181; 436/161; 422/101

(57) ABSTRACT

The present invention provides a method of detecting trace anions in solutions at a parts per billion (ppb) concentration level or less using existing anion detection technology, by employing a novel sample preparation method conducted prior to injection into a detection unit. The method includes the steps of: adding a precipitant to at least a portion of the solution; evaporating the solution, whereby a trace anion-rich solution is formed; and detecting the level of the trace anions in the trace anion-rich solution to at least a ppb concentration level. As such, any existing detection unit designed for measuring anions, known to those skilled in the art, can be used without modification. This results in a cost and time effective method of detecting trace anions in solution at a ppb concentration level. The invention also provides a system for effectuating the novel method of the present invention.

This invention relates generally to a method for detecting trace anions in a liquid solution. In particular, the present invention relates to a method for detecting trace anions in concentrated acid and/or base solutions where the sample is evaporated and the anions are precipitated prior to injection into an anion detection means.

### BACKGROUND OF THE INVENTION

Industries using or manufacturing concentrated acid and/or base solutions need to detect trace anions in these solutions, for example, to insure purity. However, detecting anions in concentrated acid and base solutions is difficult. Semiconductor Equipment and Materials International (SEMI) describes methods to detect anions in concentrated acids and bases, but only at a parts per million (ppm) concentration level.

One problem encountered with detecting trace anions in concentrated acid and base solutions is that the solutions have large amounts of typical ions, such as, fluoride. The problem associated with such fluoride ions is that hey make it quite difficult to detect and measure other trace anions present in the concentrated solutions, due to the fact that they interfere with the trace anions during detection.

Attempts to detect anions in specimens and solutions using commercial detection devices, such as, ion chromatography (IC) units, have been made. Primarily, these attempts have included modifying the IC unit itself to achieve better anion detection.

One attempt involves a process and apparatus for the determination of components in specimens where the IC process is modified to include a more highly concentrated eluent mixed with extra-pure water ahead of the separation column of the IC unit. The IC unit is modified to effectuate the process.

Another method requires the removal of selected polyvalent anions or cations from a liquid sample stream as pretreatment for the analysis of the liquid stream. Anions of interest are precipitated by passing the liquid sample through ion exchange resin prior to analysis. The IC unit is modified to include such an ion exchange resin column.

Still others have used quantitative analysis of weakly ionized anions or cations for such detection. According to this method, a sample solution is added to a first cation exchange resin bed and eluted with a strong acid. The effluent is directed to a second cation exchange resin bed where the eluent is precipitated and the effluent is directed to a conductivity cell for anion measurement.

Prevalent in these and other prior art attempts to detect trace anions using IC technology is that the IC apparatus itself is modified to effectuate the detection. These required modifications increase the cost of the IC unit and the costs associated with operating and maintaining the unit. In addition, the added steps in the IC detection process, which are a result of the modifications, may lead to increased testing times. To overcome these drawbacks, the present invention is directed to a method for detecting trace anions in solutions that does not require modifying the detection equipment.

### SUMMARY OF THE INVENTION

The present invention provides a method of detecting trace anions in solutions at a parts per billion (ppb) concentration level, using existing commercially available detection means, e.g., an IC unit, by employing a novel sample preparation method conducted prior to injection into the detection means.

A method for detecting trace anions in solution according to the present invention comprises the steps of:

(a) adding a precipitant to at least a portion of the solution;

(b) evaporating the solution from step (a), whereby the trace anions are precipitated to form a trace anion-rich solution; and

(c) detecting the level of the trace anions in the trace anion-rich solution to at least a ppb concentration level.

The evaporation described in step (b) above may comprise the steps of:

(1) heating the solution from step (a) above; and

(2) passing anion-free gas over the solution from step (1) while heating the solution.

In addition, the method of the present invention for detecting trace anions, may further comprise the step of dissolving the anions in the trace anion-rich solution prior to detecting the level of the trace anions to at least a ppb concentration level.

As such, any existing detection means designed for measuring anions, known to those skilled in the art, can be used without modification. This results in a cost and time effective method of detecting trace anions in solution to at least a ppb concentration level.

The invention also provides for a system for effectuating the novel method of the present invention, the system comprising:

(a) a means for adding a precipitant to at least a portion of the solution;

(b) a means for evaporating the solution from (a), whereby the trace anions are precipitated to form a trace anion-rich solution; and

(c) a means for detecting the level of the trace anions in the trace anion-rich solution to at least a ppb concentration level.

### DETAILED DESCRIPTION OF THE DRAWINGS

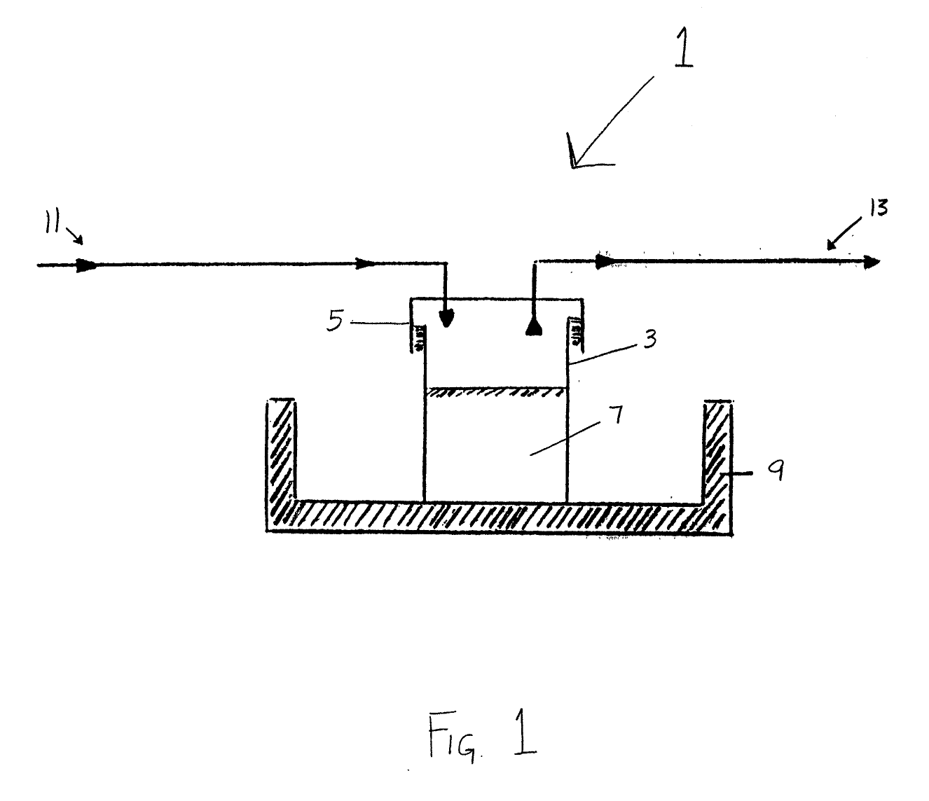

FIG. 1 is a schematic diagram of the apparatus of the present invention for the preparation of the sample prior to injection into an anion detection means.

### DETAILED DESCRIPTION OF THE PREFERRED EMBODIMENTS

The present method and system are applicable to the analysis of trace anions in concentrated acid and base solutions using an anion detector, e.g., an IC unit. It has been found that evaporating a sample, while simultaneously precipitating the anions in the sample, prior to injection into an anion detector, unexpectedly results in the ability to detect trace anions to at least a concentration level in the parts per billion.

Referring to FIG. 1, a system, represented generally by reference numeral 1, is provided for preparing liquid solution 7 prior to injection into an anion detector. A predetermined amount of liquid solution 7, which may include, for example, concentrated acid and base solutions, is measured and placed in beaker 3 having cover 5. Anion-free precipitant solution is added to liquid solution 7 to precipitate the anions. Beaker 3 is placed on hot-block 9 and heated, while anion-free gas flows via conduit 11 over liquid solution 7. The anion-free gas and solution fumes are exhausted via conduit 13 from beaker 3. When liquid solution 7 is completely evaporated, and the anions are fully precipitated, the resulting precipitant can be directly injected into an anion detector (not shown), preferably after being dissolved in high-purity deionized water.

With this technique, evaporation is faster, contamination from the surrounding atmosphere is prevented, and several solutions of different concentrated acids and/or bases can be evaporated simultaneously without cross-contamination. Low ppb, and in some cases less than 1 ppb, detection limits are feasible depending on the initial volume of the concentrated solution.

Concentrated acid and base solutions suitable for analyzation by the method of the present invention include, for example, hydrofluoric acid, ammonium fluoride, nitric acid, hydrochloric acid, buffered oxide etchants, ammonium hydroxide, and mixtures thereof. The concentration of the solution is about 1% to about 70%.

Trace anions in concentrated acid or base solutions include, for example, nitrate, phosphate, sulfate, sulfite, bromide, and chloride.

Suitable anion-free precipitant includes, for example, alkali metal hydroxide solution, alkaline-earth metal hydroxide solution, and mixtures thereof. Preferably, alkali metal hydroxide solution, such as, for example, potassium hydroxide, sodium hydroxide, and mixtures thereof, is used to precipitate anions. The precipitant is typically present in a concentration of about 0.1 Molar (M) to a point of saturation. By saturation, it is meant that the solution contains an amount of dissolved hydroxide so that no more will dissolve into the solution at a given temperature and pressure. More preferably, potassium hydroxide solution is used, and it is present in a concentration from about 0.1 M to 1 M. The volume of precipitant used in the process of the present invention preferably ranges from about 0.1 milliliters (ml) to 1 ml. However, depending on the starting volume of sample to be analyzed, the amount of precipitant used can be adjusted to achieve the desired precipitation.

Suitable anion-free, neutral gas that may be used in the evaporation process includes, for example, nitrogen, anion-free air, helium, and mixtures thereof. The gas flows over the sample at a pressure of about 0 to 10 bar. Preferably, nitrogen gas is used at a pressure of about 0.1 to 0.2 psi.

Any suitable heating means designed for heating liquid samples may be used. In the present invention, a hot-block is operated at a temperature of about 50° C. to 200° C., resulting in a sample evaporation time of about less than 1 hour to about 24 hours, depending on the initial volume of sample to be evaporated. The temperature of the heating, in conjunction with the initial sample volume can be adjusted to achieve desired evaporation rates.

High purity DI water is used to dissolve the precipitated anion crystals prior to injection into the IC unit. For purposes of the present invention, high purity DI water is that water having less than 5 ppb of anions. About 1 gram (g) to 10g of DI water is used to dissolve the precipitated anion crystals. Preferably, about 5 g to about 10 g of DI water is used, depending on the concentrated acid or base solution sample evaporated.

The present invention is further illustrated by the examples set forth below.

Test Procedure TP-QAS-608: Trace anions in HF by IC

| | | Operable Range | Preferred Range | Specific Range |
|---|---|---|---|---|
| TP-QAS-608 | Hydroxide Salt | KOH/NaOH | KOH | KOH |
| | Concentration | 0.1 M-saturation | 0.1 M-1 M | 0.1 M |
| | Amount | — | 0.1 ml-1 ml | 0.5 ml |
| | Hot-block Temp. | 100-200° C. | 140-160° C. | 150° C. |

| | |
|---|---|
| Sample Volume | Dependant on detection limits |

### EXAMPLE 1

| Spike and Recovery Data: | |
|---|---|
| HF 40%: | 10 ppb detection limits for bromide, nitrate, |
| | phosphate and sulfate. |
| | 10 ppb spike and recovery data. |
| HF 10:1: | 50 ppb detection limits for bromide, nitrate, |
| | phosphate and sulfate. |
| | 50 ppb and 100 ppb spike and recovery data. |

The HF standard was prepared by SEMI C1.8-95 guidelines.
For HF with anions-spec. less than 100 ppb, about 100 grams of HF sample was used.
For HF with anions-spec. higher than 100 ppb, about 5 grams of HF sample was used.

Recovery:

| | | | | | |
|---|---|---|---|---|---|
| Replicate | Chloride | Bromide | Nitrate | Phosphate | Sulfate |

HF 40%

| | | | | | |
|---|---|---|---|---|---|
| 1 | / | 0 | 23 | 20 | 44 |
| 2 | / | 1 | 17 | 19 | 42 |
| Average | / | 0.5 | 20 | 19.5 | 43 |
| Spike 1(10 ppb) | / | 10 | 32 | 30 | 51 |
| Recovery (%) | / | 95 | 120 | 105 | 80 |
| Spike 2(10 ppb) | / | 9 | 29 | 32 | 53 |
| Recovery (%) | / | 85 | 90 | 125 | 100 |
| Spike 3(10 ppb) | / | 10 | 28 | 32 | 53 |
| Recovery (%) | / | 95 | 80 | 125 | 100 |

HF 10:1

| | | | | | |
|---|---|---|---|---|---|
| 1 | / | 0 | 98 | 0 | 56 |
| Average | / | 0 | 98 | 0 | 56 |
| Spike 1(50 ppb) | / | 43 | 154 | 54 | 115 |
| Recovery (%) | / | 86 | 112 | 108 | 112 |
| Spike 2(100 ppb) | / | 87 | 211 | 108 | 171 |
| Recovery (%) | / | 87 | 113 | 108 | 115 |

### EXAMPLE 2

Test Procedure TP-QAS-609: Trace Anions in Nitric Acid by IC

| | | Operable Range | Preferred Range | Specific Range |
|---|---|---|---|---|
| TP-QAS-609 | Hydroxide Salt | KOH/NaOH | KOH | KOH |
| | Concentration | 0.1 M-saturation | 0.1 M-1 M | 0.1 M |
| | Amount | — | 0.1 ml-1 ml | 0.5 ml |
| | Hot-block Temp. | 100-200° C. | 140-160° C. | 150° C. |

| | |
|---|---|
| Sample Volume | Dependant on detection limits |

Spike and Recovery Data:

40 ppb detection limits for phosphate and sulfate

40, 80 and 200 ppb spike and recovery data

The nitric acid standard was prepared by SEMI C1.12-96 guidelines.

About 5 grams of nitric acid sample was used.

Recovery:
HNO₃ 69%

| Replicate | Chloride | Bromide | Nitrate | Phosphate | Sulfate |
|---|---|---|---|---|---|
| 1 | / | / | / | 0 | 0 |
| Average | / | / | / | 0 | 0 |
| Spike 1(40 ppb) | / | / | / | 41 | 46 |
| Recovery (%) | / | / | / | 103 | 115 |
| Spike 2(40 ppb) | / | / | / | 37 | 44 |
| Recovery (%) | / | / | / | 92.5 | 110 |
| Spike 3(80 ppb) | / | / | / | 77 | 84 |
| Recovery (%) | / | / | / | 96.2 | 105 |
| Spike 4(200 ppb) | / | / | / | 198 | 199 |
| Recovery (%) | / | / | / | 99 | 99.5 |

### EXAMPLE 3

Test Procedure TP-QAS-610: Trace Anions in
Buffered Oxide Etchants (BOE) & LCP by IC

| | | Operable Range | Preferred Range | Specific Range |
|---|---|---|---|---|
| TP-QAS-610 | Hydroxide Salt | KOH/NaOH | KOH | KOH |
| | Concentration | 0.1 M-saturation | 0.1 M-1 M | 0.1 M |
| | Amount | — | 0.1 ml-1 ml | 0.5 ml |
| | Hot-block Temp. | 100-200° C. | 180-200° C. | 200° C. |

| | |
|---|---|
| Sample Volume | Dependant on detection limits |

Spike and Recovery Data:

50 ppb detection limits for nitrate and sulfate.

100 ppb detection limits for bromide and phosphate.

50, 100 and 700 ppb spike and recovery data.

The BOE standard was prepared by SEMI C2.2-95 guidelines.

About 5 grams of BOE sample was used.

Recovery:
BOE 10:1 OHS

| Replicate | Chloride | Bromide | Nitrate | Phosphate | Sulfate |
|---|---|---|---|---|---|
| 1 | / | 0 | 74 | 0 | 140 |
| Average | / | 0 | 74 | 0 | 140 |
| Spike 1 (50 ppb) | / | 42 | 126 | 42 | 196 |
| Recovery (%) | / | 84 | 104 | 84 | 112 |
| Spike 2 (100 ppb) | / | 84 | / | 91 | 240 |
| Recovery (%) | / | 84 | / | 91 | 100 |
| Spike 3 (100 ppb) | / | 95 | / | 90 | 255 |
| Recovery (%) | / | 95 | / | 90 | 115 |
| Spike 4 (700 ppb) | / | 696 | 893 | 578 | 890 |
| Recovery (%) | / | 99 | 117 | 83 | 107 |

### EXAMPLE 4

Test Procedure TP-QAS-613: Trace Anions in Hydrochloric Acid (HCl) by IC

| | | Operable Range | Preferred Range | Specific Range |
|---|---|---|---|---|
| TP-QAS-613 | Hydroxide Salt | KOH/NaOH | KOH | KOH |
| | Concentration | 0.1 M-saturation | 0.1 M-1 M | 0.1 M |
| | Amount | — | 0.1 ml-1 ml | 0.5 ml |
| | Hot-block Temp. | 100-200° C. | 140-160° C. | 150° C. |

| | |
|---|---|
| Sample Volume | Dependant on detection limits |

Spike and Recovery Data:

50 ppb detection limits for phosphate and sulfate.

50 ,400, and 800 ppb spike and recovery data.

The HCl standard was prepared by SEMI C1.7-95 guidelines.

About 50 grams of HCl sample was used.

Recovery:

| | | | | | |
|---|---|---|---|---|---|
| Replicate | Chloride | Bromide | Nitrate | Phosphate | Sulfate |

HCl 37%

| | | | | | |
|---|---|---|---|---|---|
| 1 | / | / | / | 0 | 8 |
| 2 | / | / | / | 0 | 6 |
| Average | / | / | / | 0 | 7 |
| Spike 1 (50 ppb) | / | / | / | 41 | 49 |
| Recovery (%) | / | / | / | 82 | 84 |
| Spike 2 (50 ppb) | / | / | / | 39 | 48 |
| Recovery (%) | / | / | / | 78 | 82 |
| Spike 3 (50 ppb) | / | / | / | 47 | 54 |
| Recovery (%) | / | / | / | 94 | 96 |
| Spike 4 (50 ppb) | / | / | / | 42 | 50 |
| Recovery (%) | / | / | / | 84 | 86 |
| Spike 5 (400 ppb) | / | / | / | 410 | 425 |
| Recovery (%) | / | / | / | 103 | 105 |

HCl 37%

| | | | | | |
|---|---|---|---|---|---|
| 1 | / | / | / | 0 | 22 |
| 2 | / | / | / | 0 | 24 |
| Average | / | / | / | 0 | 23 |
| Spike 6 (800 ppb) | / | / | / | 861 | 680 |
| Recovery (%) | / | / | / | 108 | 82 |

### EXAMPLE 5

Test Procedure TP-QAS-615: Trace Anions in
Ammonium Hydroxide (NH₄OH) by IC

| | | Operable Range | Preferred Range | Specific Range |
|---|---|---|---|---|
| TP-QAS-615 | Hydroxide Salt | KOH/NaOH | KOH | KOH |
| | Concentration | 0.1 M-saturation | 0.1 M-1 M | 0.1 M |
| | Amount | — | 0.1 ml-1 ml | 0.5 ml |
| | Hot-block Temp. | 50-200° C. | 60-120° C. | 80° C. |

| | |
|---|---|
| Sample Volume | Dependant on detection limits |

Spike and Recovery Data:

50 ppb detection limits for chloride, bromide, nitrate, phosphate, and sulfate.

50 and 100 ppb spike and recovery data.

The NH₄OH standard was prepared by SEMI C1.4-95 guidelines.

About 50 grams of sample was used.

Recovery:
NH₄OH

| Replicate | Chloride | Bromide | Nitrate | Phosphate | Sulfate |
|---|---|---|---|---|---|
| 1 | 7 | 0 | 7 | 0 | 2 |
| 2 | 9 | 0 | 6 | 0 | 5 |
| 3 | 9 | 0 | 6 | 0 | 3 |
| 4 | 8 | 0 | 8 | 0 | 7 |
| 5 | 6 | 0 | 5 | 0 | 3 |
| 6 | 9 | 0 | 5 | 0 | 8 |
| Average | 8 | 0 | 6 | 0 | 5 |
| Spike 1 (50 ppb) | 58 | 47 | 53 | 57 | 52 |
| Recovery (%) | 100 | 94 | 94 | 114 | 94 |
| Spike 2 (50 ppb) | 58 | 49 | 49 | 49 | 57 |
| Recovery (%) | 100 | 98 | 86 | 98 | 104 |
| Spike 3 (100 ppb) | 118 | 104 | 98 | 91 | 109 |
| Recovery (%) | 110 | 104 | 92 | 91 | 104 |

As is evident from the above examples, by preparing a concentrated acid or base solution using the method and apparatus of the present invention, detection of trace anions at a ppb level is achieved.

While the present invention has been described above with reference to specific embodiments thereof, it is apparent that many changes, modifications and variations can be made without departing from the inventive concept disclosed herein. Accordingly, it is intended to embrace all such changes, modifications and variations that fall within the spirit and broad scope of the appended claims.

What is claimed is:

1. A method for detecting trace anions in solution comprising the steps of:
(a) adding a precipitant to at least a portion of said solution;
(b) evaporating said solution from step (a), whereby said trace anions are precipitated to form a trace anion-rich solution; and
(c) detecting the level of said trace anions in said trace anion-rich solution to at least a ppb concentration level.

2. The method of claim 1, wherein said evaporation step (b) comprises the steps of:
(1) heating said solution from step (a); and
(2) passing anion-free gas over said solution from step (1) while heating said solution.

3. The method of claim 1, further comprising the step of dissolving the anions in said trace anion-rich solution prior to detecting said level of said trace anions to at least a ppb concentration level.

4. The method of claim 1, wherein said solution of step (a) is selected from the group consisting of: hydrofluoric acid, nitric acid, hydrochloric acid, ammonium fluoride, buffered oxide etchants, ammonium hydroxide, and mixtures thereof.

5. The method of claim 1, wherein said trace anions are selected from the group consisting of: bromide, nitrate, phosphate, sulfate, sulfite, and chloride.

6. The method of claim 1, wherein said precipitant is selected from the group consisting of: alkali metal hydroxide solution, alkaline-earth metal hydroxide solution, and mixtures thereof.

7. The method of claim 6, wherein said precipitant is alkali metal hydroxide solution selected from the group consisting of: potassium hydroxide, sodium hydroxide, and mixtures thereof.

8. The method of claim 6, wherein said precipitant has a concentration from about 0.1 M to saturation.

9. The method of claim 2, wherein said solution from step (a) is heated to a temperature from about 50° C.to 200° C.

10. The method of claim 2, wherein said anion-free gas is selected from the group consisting of: nitrogen, anion-free air, helium, and mixtures thereof.

11. The method of claim 2, wherein said anion-free gas flows over said solution from step (1) at a pressure of about 0 to 10 bar.

12. The method of claim 3, wherein said anions are dissolved with deionized water.

13. A method for detecting trace anions in a concentrated acid or base solution comprising the steps of:
(a) adding a precipitant to at least a portion of said solution;
(b) evaporating said solution from step (a), whereby said trace anions are precipitated to form a trace anion-rich solution; and
(c) detecting the level of said trace anions in said trace anion-rich solution to at least a ppb concentration level.

14. The method of claim 13, wherein said evaporation step (b) comprises the steps of:
(1) heating said solution from step (a); and
(2) passing anion-free gas over said solution from step (1) while heating said solution.

15. The method of claim 13, further comprising the step of dissolving the anions in said trace anion-rich solution prior to detecting said level of said trace anions to at least a ppb concentration level.

16. The method of claim 13, wherein said concentrated acid or base solution is selected from the group consisting of: hydrofluoric acid, nitric acid, hydrochloric acid, ammonium fluoride, buffered oxide etchants, ammonium hydroxide, and mixtures thereof.

17. The method of claim 13, wherein said trace anions are selected from the group consisting of: bromide, nitrate, phosphate, sulfate, sulfite, and chloride.

18. The method of claim 13, wherein said precipitant is selected from the group consisting of: alkali metal hydroxide solution, alkaline-earth metal hydroxide solution, and mixtures thereof.

19. The method of claim 18, wherein said precipitant is alkali metal hydroxide solution selected from the group consisting of: potassium hydroxide, sodium hydroxide, and mixtures thereof.

20. The method of claim 18, wherein said precipitant has a concentration from about 0.1 M to saturation.

21. The method of claim 14, wherein said solution of step (a) is heated to a temperature from about 50° C.to 200° C.

22. The method of claim 14, wherein said anion-free gas is selected from the group consisting of: nitrogen, anion-free air, helium, and mixtures thereof.

23. The method of claim 14, wherein said anion-free gas flows over said solution from step (1) at a pressure of about 0 to 10 bar.

24. The method of claim 15, wherein said anions are dissolved in deionized water.

25. A system for detecting trace anions in solution comprising:
(a) a means for adding a precipitant to at least a portion of said solution;
(b) a means for evaporating said solution from (a), whereby said trace anions are precipitated to form a trace anion-rich solution; and
(c) a means for detecting the level of said trace anions in said trace anion-rich solution to at least a ppb concentration level.

26. The system of claim 25, wherein said evaporating means comprises:
(1) a means for heating said solution from (a); and
(2) a means for passing anion-free gas over said solution from (1) while heating said solution.

27. The system of claim 25, further comprising a means for dissolving the anions in said trace anion-rich solution prior to detecting said level of said trace anions to at least a ppb concentration level.
